(19) United States
(12) Patent Application Publication
(10) Pub. No.: US 2009/0142070 A1
(43) Pub. Date: Jun. 4, 2009

(54) Methods and apparatus for supporting fiber span loss and dispersion measurements in the presence and absence of dispersion compensation elements

(75) Inventors: Mark E. Boduch, Geneva, IL (US); Kimon Papakos, Chicago, IL (US); Julia Y. Larikova, Naperville, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 11/998,440

(22) Filed: Nov. 29, 2007

(51) Int. Cl. H04B 10/12

(52) U.S. Cl. 398/148

(57) ABSTRACT

An example embodiment of the invention includes a method and apparatus for supporting fiber span loss and dispersion measurements in the presence or absence of dispersion compensation elements (DCE). The technique may be used to configure a network link by accessing an optical signal at an ingress side of a connection point for a DCE coupling an egress side of a fiber span at the ingress side of the DCE to an optical amplifier at a connection point for an egress side of the DCE. The technique may include determining chromatic dispersion of the fiber span based on the optical signal and reporting information associated with chromatic dispersion. As a result, the technique may be used, for example, during initial system installation when user data signals and the DCE are not present as well as after the network begins carrying user traffic and after a DCE has been installed.

### BACKGROUND OF THE INVENTION

Optical fiber communications systems commonly employ dense wavelength division multiplexing (DWDM) to provide additional capacity by multiplexing a number of optical carrier channels on a single optical fiber using a range of optical wavelengths. Conventional fiber optic systems may transmit optical signals in a wavelength range where longer wavelength components are subject to slightly longer propagation delays than shorter wavelength components. This phenomenon, known as chromatic dispersion, causes light pulses to spread or widen as they travel down an optical fiber. As the pulses widen, they may begin to overlap into adjacent bit cells resulting in communication errors such as bit errors thereby potentially limiting bandwidth and maximum transmission distance of a fiber span between network nodes. These errors may become even more pronounced as a transmission rate increases.

Known compensation techniques are used to reduce the effects of dispersion, including passive dispersion compensation elements (DCE), such as a spool of dispersion compensating fiber, and more recently, tunable dispersion compensation elements. With the introduction of tunable DCEs, there is a need for automatically measuring the amount of dispersion present on a span of fiber prior to setting the tunable DCE in order to correctly compensate dispersion. Furthermore, it may be necessary to determine fiber and DCE insertion losses in order to properly program optical amplifiers within the network.

During installation and deployment of an optical network, testing may be performed to characterize fiber dispersion and fiber insertion loss. Prior to installation of the DCE, fiber dispersion is measured and an appropriate DCE may be installed or tuned. After installation is complete and the network begins carrying user traffic, dispersion or insertion loss measurements may need to be performed as the network is reconfigured as a result of design changes or equipment failure.

### SUMMARY OF THE INVENTION

A method and corresponding apparatus for configuring a network link according to an example embodiment of the invention may include accessing an optical signal at an ingress side of a connection point for a dispersion compensation element (DCE) coupling an egress side of a fiber span at the ingress side of the DCE to an optical amplifier at a connection point for an egress side of the dispersion compensation element. The example embodiment may include determining chromatic dispersion of the fiber span based on the optical signal and reporting information associated with chromatic dispersion.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating example embodiments of the present invention.

FIG. 1 is a network diagram of an optical communications network element according to an example embodiment of the invention;

FIG. 2 is a block diagram illustrating network elements implementing an example embodiment of the invention;

FIG. 3 is a block diagram illustrating network elements in additional detail according to an example embodiment of the invention;

FIG. 4 is a block diagram of a circuit pack and related elements according to an example embodiment of the invention;

FIG. 5 is a block diagram of a circuit pack and related elements according to an alternative example embodiment of the invention;

FIG. 6 is a block diagram of a circuit pack and related elements according to another alternative example embodiment of the invention;

FIG. 7 is a schematic diagram illustrating in further detail an example embodiment similar to that described in FIG. 4;

FIG. 8 is a schematic diagram illustrating in further detail an example embodiment similar to that described in FIG. 5; and

FIG. 9 is a flow diagram of an example process performed in accordance with example embodiments of the invention.

### DETAILED DESCRIPTION OF THE INVENTION

A description of example embodiments of the invention follows.

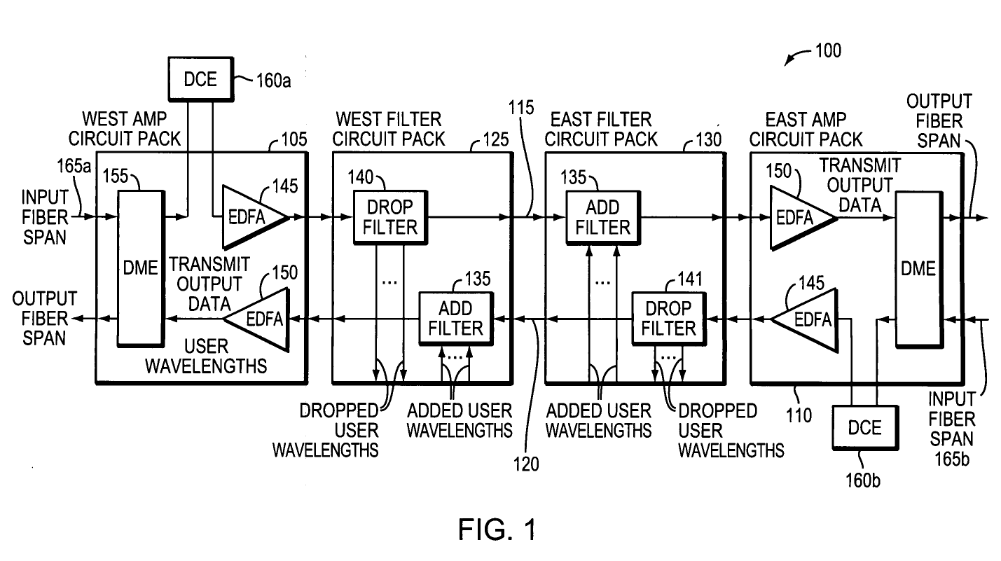

FIG. 1 is a network diagram of an optical communications network element 100 illustrating aspects of an example embodiment of the invention. The optical communications network element 100 may include network element components such as amplifier circuit packs 105, 110 at each end of the network element coupled to each other via optical fibers 115, 120. The optical communications network element 100 may be implemented using dense wavelength division multiplexing (DWDM) technology whereby multiple optical carrier signals are multiplexed on a single optical fiber using multiple wavelengths.

As used herein, a signal may refer to a particular wavelength (e.g., 1510 nm) or may refer to a wavelength modulated on a carrier wave or more generally as a communication signal that includes multiple wavelengths (e.g., 44 different wavelengths using DWDM technology).

The amplifier circuit packs 105, 110 may be coupled to filter circuit packs 125, 130 such as a reconfigurable optical add drop multiplexer (ROADM). A ROADM 125, 130 is an optical add-drop multiplexer that allows the network element 100 to remotely switch traffic in a DWDM network at the wavelength layer. For example, an add filter 135 may be used to add user wavelengths at a transmitting node, and a drop filter 140 may be used to drop user wavelengths at a receiving node. The ROADM 125, 130 also allows a system operator to remotely configure/reconfigure the network.

The amplifier circuit packs 105, 110 may include optical amplifiers, such as an erbium doped fiber amplifier (EDFA) 145, 150 for use in amplifying a transmitted optical signal (e.g., via EDFA 150) at a transmitting network node or a received optical signal at a receiving network node, as needed (e.g. via EDFA 145).

The amplifier circuit pack 105, 110 may also include a dispersion measurement element (DME) 155 for use in measuring, for example, chromatic dispersion of an optical fiber span. Chromatic dispersion describes a phenomenon whereby light pulses spread or widen as they travel down an optical fiber. As the pulses widen, they may begin to overlap into adjacent bit fields resulting in communication errors, such as bit errors thereby limiting bandwidth and maximum deployable fiber length.

As used herein, chromatic dispersion or material dispersion or simply dispersion may be used interchangeably. Furthermore, information associated with chromatic dispersion of a fiber span may include information in the form of a metric, an estimate, a level, a result (e.g., above or below a threshold) and the like.

Chromatic dispersion effects may be mitigated through the use of a dispersion compensation element (DCE) 160a-b. The DCE 160a-b may be coupled to the circuit packs 105, 110 via input and output connectors (not shown) to compensate for chromatic dispersion of, for example, an input fiber span 165a-b. However, there may be situations where a particular fiber span does not need to be compensated for, and in these cases, the DCE 160a-b may be replaced with a simple optical jumper cable. Note that “dispersion compensation element” and “dispersion compensation circuit pack” may be used interchangeably herein and are collectively referred to as a “DCE.”

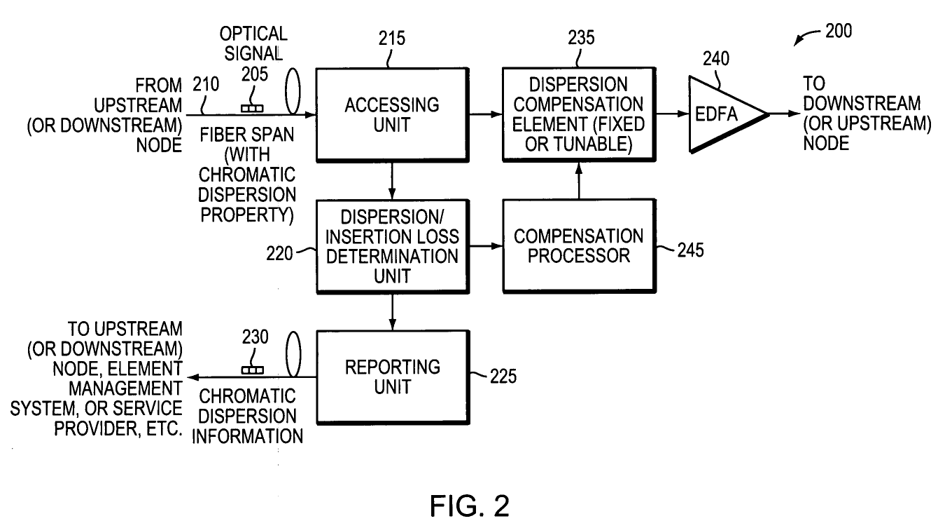

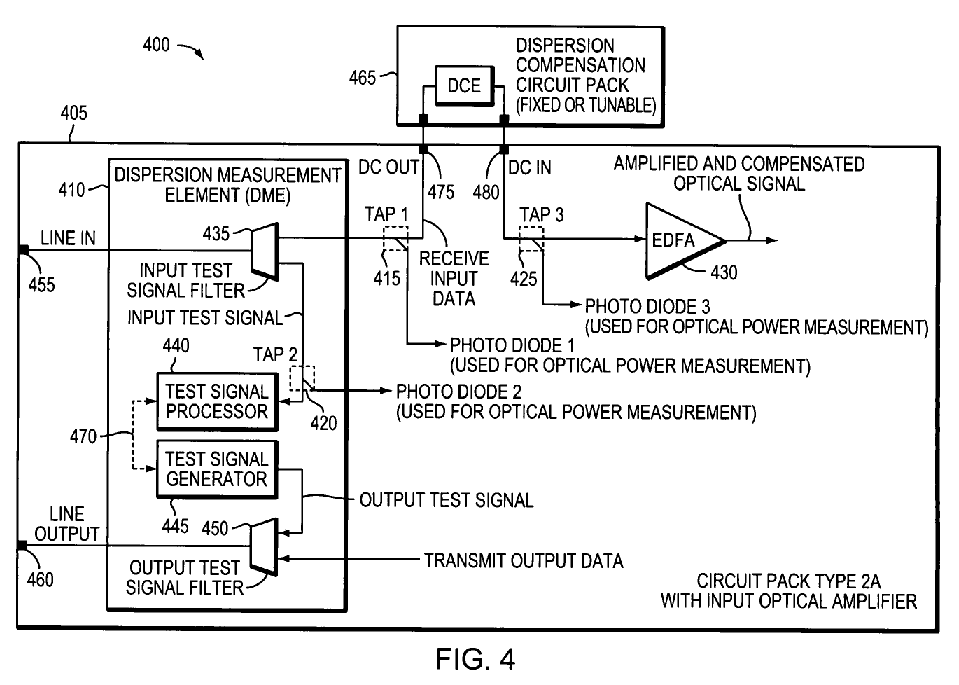

FIG. 2 is a block diagram illustrating an example embodiment of the invention. Optical signals 205 may be communicated via a fiber span 210 from another network node, such as an upstream or downstream node (not shown). The optical signal may be accessed by an accessing unit 215 via, such as a wavelength filter or tap. A representation of the optical signal 205 may be communicated to a dispersion/insertion loss determination unit 220. The dispersion/insertion loss determination unit 220 may be used to determine the chromatic dispersion of the fiber span 210, insertion loss of the fiber span 210, and insertion loss of the DCE 235 using the techniques discussed below in reference to FIGS. 4-6. Additional details may also be found in applicants' co-pending U.S. patent application Ser. No. 11/531,444, which is incorporated herein by reference in its entirety.

The dispersion/insertion loss determination unit 220 may communicate determined dispersion results to a reporting unit 225 and compensation processor 245. The reporting unit 225 may report chromatic dispersion information 232 to an upstream (or downstream) node, element management system (EMS), service provider, server, or the like. A fixed or tunable dispersion compensation element 235 may be used compensate for chromatic dispersion. The compensation processor 245 may be used to configure a tunable DCE 235 based on a metric associated with the determined chromatic dispersion, a predetermined value, event, or the like. An amplifier (e.g., EDFA) 240 may be used to amplify the optical signal prior to transmitting the optical signal to a downstream or upstream network node.

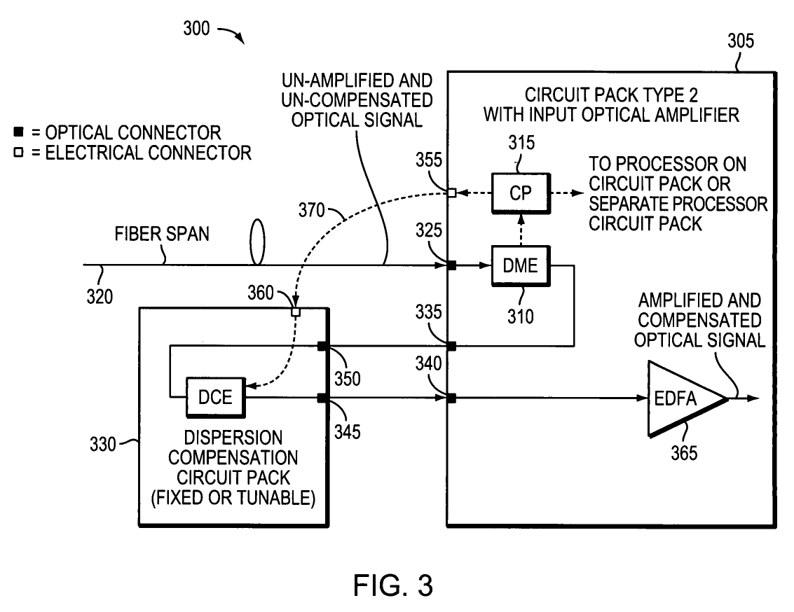

FIG. 3 is a block diagram of a circuit pack 305 illustrating components of a network element 300 according to an example embodiment of the invention and may include a circuit pack 305 (e.g., type 2 with an optical amplifier) and a dispersion compensation element (fixed or tunable) 330. The circuit pack 305 may include a DME 310, compensation processor 315, and input amplifier (e.g., EDFA) 365. Note that the DME 310, DCE 330, and compensation processor 315 can all be combined on a single circuit pack separate from the input optical amplifier, or all three elements can reside on the same circuit pack containing the input optical amplifier 365, or combination thereof. However, keeping the DCE 330 separate from the input optical amplifier 365 provides additional flexibility by accommodating use of either a fixed (typically less expensive) or tunable (typically more expensive) DCE 330 in a modular fashion. Furthermore, the circuit pack containing the input optical amplifier may also include the ROADM component (125) and/or the output optical amplifier (150).

Unamplified and uncompensated optical signals may be communicated from other network elements (not shown) to the circuit pack 305 via a fiber span 320 coupled to an input connector 325. The input optical signal flows to the DME 310 where chromatic dispersion of the fiber span 320 may be measured with the DME 310 using the technique described above in reference to FIG. 2, and further described below with respect to particular implementations described with reference to FIGS. 4-6.

The circuit pack 305 may also contain electrical connections and corresponding transmission paths (shown as a dotted line) between the compensation processor 315, DME 310, and DCE 330. The compensation processor 315 may use these connections to send control information to, or receive status information from, the dispersion compensation element 330. In this manner, the compensation processor 315 may be used to control the fiber dispersion measurement and to set the DCE 330 when a tunable DCE 330 is used. The compensation processor 315 may initiate dispersion measurements by instructing the DME 310 to execute a measurement after which the compensation processor 315 gathers the results of the measurement and transforms the results into a format that can be used to correctly set the tunable DCE 330.

Based on the determined dispersion, a fixed DCE 330 may be coupled to the circuit pack 305 such that the optical signal flows out of the circuit pack 305 via optical connector 335, into the DCE 330 via optical connector 350, through the DCE 330, out the DCE's output optical connector 345, back to the circuit pack 305 via input connector 340 and finally to the EDFA 365. The EDFA 365 may then amplify and compensate the optical signal as necessary.

In the case of the tunable DCE 330, the compensation processor 315 may be used to communicate a control signal to the DCE 330 for use in tuning the amount of dispersion to be compensated for. The compensation processor may receive an electrical signal from the DME 310 and based on this signal may also communicate an electrical control signal to the DCE 330 via an electrical connection 370 via connectors 355, 360.

Although FIG. 3 depicts a tunable DCE 330 under direct control of the circuit pack 305 on which the input optical amplifier 365 resides, the compensation processor 315 may be physically separate from the input optical amplifier circuit pack 305 and the DCE 330. In this case, the compensation processor 315 may be used to communicate information to and from the DCE 330 and the circuit pack 305 on which the input optical amplifier 365 resides.

An example embodiment of a method and corresponding apparatus of configuring a network link may include accessing an optical signal at an ingress side of a connection point for a dispersion compensation element (DCE) coupling an egress side of a fiber span at the ingress side of the DCE to an optical amplifier at a connection point for an egress side of the DCE. The method may further include determining chromatic dispersion of the fiber span based on the optical signal, and reporting information associated with the chromatic dispersion. The optical signal may be an optical test signal and accessing the optical test signal may include separating at least a portion of the optical test signal from other signals before determining chromatic dispersion or insertion of the fiber span or DCE insertion loss.

An alternative example embodiment may further include determining a first power level of the optical signal at the ingress side of the DCE (or DCE connection point) and a second power level at a transmitter side of a forward path of the fiber span toward the DCE (or DCE connection point) and reporting fiber span insertion loss based on a differential of the first and second power levels. Accessing the optical signal may further include tapping a percentage of the optical test signal along with other optical signals, if present, and separating the optical test signal from the other optical signals, if present.

In another example embodiment, the method and corresponding may further include determining chromatic dispersion by detecting a time difference between two optical signals at different wavelengths in a forward direction of the fiber span, and may be determined in the presence or absence of the DCE. Determining chromatic dispersion may also include determining a length of the fiber span and calculating the chromatic dispersion based on the length and/or fiber type.

Another example embodiment may further include configuring the DCE based on the chromatic dispersion, or in addition or alternatively, at least one of the following: a predetermined value, stored value, calculated value, instruction, or event. Configuring the DCE may also include tuning the DCE.

In yet another example embodiment, the method and corresponding apparatus may further include accessing the optical signal at the egress side of the DCE, determining insertion loss of the DCE or fiber span based on a difference between power levels of the optical signal at the ingress and egress sides, and reporting the insertion loss and may include adjusting gain of the optical amplifier as a function of both insertion losses. The embodiment may further include accessing the optical test signal includes separating at least a portion of the optical test signal from other signals before determining the insertion loss. Determining insertion loss further includes measuring leakage power of the filtered optical test signal during a period in which no user signals are on the fiber span.

Other example embodiments may further include adjusting the gain as a function of the leakage power, and or in addition, measuring the leakage power at the egress side of the DCE. The embodiment may also include reporting insertion loss based on a differential of power levels on the ingress and egress sides of the DCE.

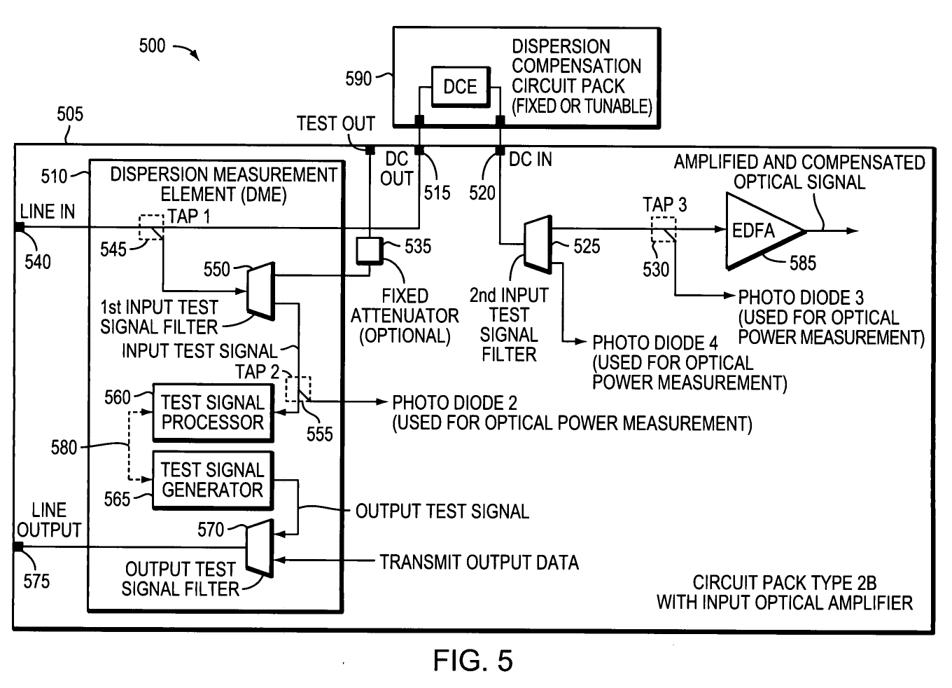

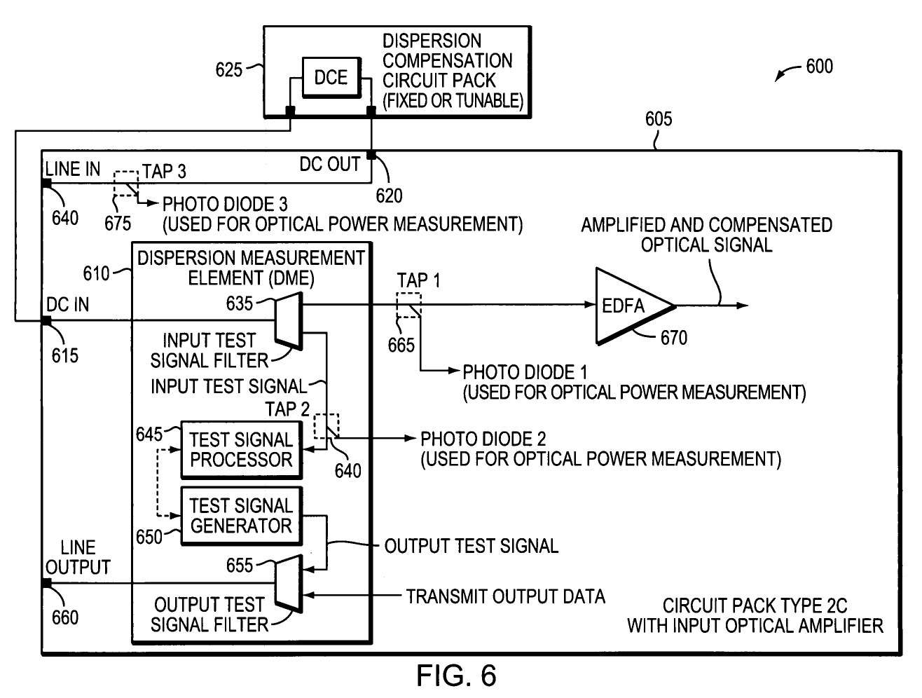

The example embodiments described above and in FIGS. 4-6 illustrate, in additional detail, alternative example implementations of a network node employing a circuit pack “type 2” as described in FIG. 3. In particular, FIG. 4 depicts a circuit pack “type 2A,” FIG. 5 depicts a circuit pack “type 2B,” and FIG. 6 depicts a circuit pack “type 2C.” Although the implementation details of each type may vary, each embodiment, nonetheless, provides the ability to measure fiber dispersion, fiber insertion loss, and DCE insertion loss, and may do so in the presence or absence of user communication signals.

FIG. 4 is a more detailed block diagram of a network element 400 employing a circuit pack (type 2A) 405 with an input optical amplifier according to an example embodiment of the invention. The circuit pack 405 may include a dispersion measurement element (DME) 410, taps 415, 425 and optical amplifier, such as an EDFA 430. The DME 410 may further include an input test signal filter 435, tap 2 420, test signal processor 440, test signal generator 445, and output test signal filter 450.

Unamplified and uncompensated optical signals arrive at a LINE IN connector 455 via a fiber span (not shown) and further propagate to the input test signal filter 435 at the DME 410. The input test signal filter 435 is chosen to separate an input test signal (or signals) of a particular wavelength (or wavelengths) from the input optical signal received at the LINE IN connector 455. The separated input test signal is transmitted to tap 2 420 where the signal is tapped and a power reduced portion of the input test signal is transmitted to, for example, photodiode 2 and the remaining power reduced portion is transmitted to the signal processor 440.

An input optical signal may arrive at the LINE IN connection 455 that includes an input test signal having a wavelength of, for example, 1510 nm. The input optical signal may include only the input test signal (e.g., during system installation) or may include the input test signal and user data communications (e.g., 44 user wavelengths). The input test signal filter 435 filters or passes through only the input test signal, which in this case may be the 1510 nm wavelength, while blocking any remaining wavelengths, if present, to the test signal processor. The 1510 nm input test signal is far enough away in frequency from the user data wavelengths, such as those located in the C-band, that the filter need not display perfect transfer characteristics, thereby simplifying the filter's design.

The filtered input test signal flows to the test signal processor 440, where dispersion may be measured or calculated based upon the received test signal. The test signal processor may transmit electrical signals to the test signal generator 445 via an electrical transmission path (depicted as dotted line 470). The test signal generator 445 generates an “output test signal” that is further transmitted to the output test signal filter 450 wherein the signal may be combined with a “transmit output data” signal at the output test signal filter 450 and further transmitted to a LINE OUTPUT connector 460. The output test signal may then be used to measure the chromatic dispersion of the fiber span at an upstream node. The output test signal filter 450 may be an optical filter of a different optical wavelength(s) than those wavelengths contained within the transmit output data signal. As the input test signal is the same wavelength as the output test signal, it is suitable for measuring dispersion present on the fiber span. In an alternative example embodiment, chromatic dispersion may also be determined using multiple wavelengths by launching a pulse train at the transmitting node simultaneously using at least two different wavelengths and measuring the phase difference of the multiple wavelengths upon arrival at the DME 410 of a receiving node.

It should be noted that dispersion measurements can be made regardless of the presence of the “transmit output data” or “receive input data” signals because the output test signal and the input test signal are used in the dispersion measurement process and it is assumed that these two signals are always available. Furthermore, due to the placement of the DCE 465, the dispersion measurements may be made in the presence or absence of the DCE 465.

Continuing to refer to FIG. 4, the “receive input data” signal flowing out the upper leg of the input test signal filter 435 includes all wavelengths not filtered out by the input test signal filter 435, that is, user data signals (e.g., C-band wavelengths), if present. The receive input data flows to tap 1 415, wherein a power reduced portion is transmitted to photodiode 1 and the remaining power reduced portion is transmitted to the DC OUT connector 475, through the DCE 465 (or optical jumper), and back in the circuit pack 405 via a DC IN connector 480. The DCE 465 may be used to compensate for the measured chromatic dispersion associated with a fiber span, and may be a fixed DCE 465 (e.g., a spool of dispersion compensation fiber) or a tunable DCE 465 thereby correcting for the effects of chromatic aspersion associated with the fiber span.

The optical signal then flows from the DC IN connector 480 to tap 3 425 wherein a power reduced portion of the optical signal is transmitted to photodiode 3 and the remaining power reduced portion of the signal is transmitted to the input optical amplifier 430. The signal (now compensated for dispersion) may be amplified by the input optical amplifier 430 to compensate for amplitude loss, as a result of, for example, fiber span insertion loss, prior to transmitting the optical signal to other network elements components.

In order to properly set the gain of the input optical amplifier 430, the insertion loss of the fiber span and the insertion loss of the DCE 465 need to be determined. This is often done during network installation, such that once the network of nodes begin carrying user traffic signals, the gain settings of all network amplifiers have been properly programmed. In addition, by setting the gain of the input optical amplifiers before the network begins carrying user traffic, placement of the correct input amplifiers can be verified before the network goes “live” (assuming there are multiple input amplifiers having different gain ranges).

Insertion loss related to the fiber span may be measured using the optical taps associated with the DME 410. For example, tap 1 415 and tap 2 420 may be used to siphon off predetermine portions of the optical power of the two outputs of the input test signal filter 435. Assuming that the “output test signal” and the “transmit output data” signals are launched at known power levels at the previous network node, the outputs of tap 1 415 and tap 2 420 may be transmitted to photodiode 1 and photodiode 2 and used to measure span insertion loss associated with the fiber between network nodes.

Insertion loss related to the DCE 465 may be measured even though the input test signal has been filtered before the signal arrives at the DCE 465 (and in the absence of user traffic). This may be done by choosing an input test signal filter 435 such that the input test signal is only partially attenuated through the filter 435. Such a filter will allow the test signal to pass to the test signal processor and would also allow an attenuated version of the input test signal to pass out the upper leg of the input test signal filter 435. For example, the input test signal filter 435 may be chosen such signals at the upper leg of the filter are attenuated by 15 dB. Consequently, it is possible to in-system measure the insertion loss of the DCE 465 by using the photodiodes associated with tap 2 and tap 3 (assuming the input test signal is present). The amplifier gain can then be set based upon the combination of in-system fiber span insertion loss and DCE insertion loss measurements. Alternatively, insertion loss of the DCE may be measured “out-of-system,” that is, prior to connecting the DCE 465 to the circuit pack 405

Thus, the implementation with respect to circuit pack “type 2A” 405 provides the ability to perform fiber dispersion, fiber insertion loss, and DCE 465 insertion loss measurements, and the measurements may be conducted in the presence or absence of user communication signals and in the presence or absence of a dispersion compensation element.

FIG. 5 is a more detailed block diagram of a network element 500 employing an example embodiment of an alternative circuit pack “type 2B” 505 according to aspects of the invention. This embodiment provides similar capabilities of the embodiment described with respect to FIG. 4, however, with the addition of a second input test filter 525, this embodiment provides a simpler method of determining total insertion loss (i.e., span and DCE) for use in programming, for example, the optical amplifier 585.

In this embodiment, the circuit pack 505 may include a DME 510, tap 3 530, input optical amplifier 585, DCE connection points 515, 520, and second input test signal filter 525, and may optionally include a fixed attenuator 535. However, in this embodiment, the optical signal is tapped upon arrival with tap 1 545 wherein a power reduced portion of the input optical signal flows to the first input test signal filter 550 and the remaining power reduced portion flows to the DC OUT connector 515. Therefore, all wavelengths of the input optical signal (e.g., a 1510 nm input test signal and/or C-band user signals) are present at the first input test signal filter 550 and the DC OUT connector 515. In addition, a second input test signal filter 525 is placed between the DC IN connector 520 and the input optical amplifier 585.

Unamplified and uncompensated optical communications signals may arrive from a previous network element (not shown) at a LINE IN connector 540 and further propagated to the DME 510 and tap 1 545. At tap 1 545, a power reduced portion of the input optical signal is “tapped” off and flows to the first input test signal filter 550 and the remaining power reduced portion flows to the DC OUT connector 515. The first input test signal filter 550 may be chosen to filter or separate out an input test signal transmitted at a wavelength of, for example, 1510 nm similar to that described above reference to FIG. 4 in order to measure the fiber span dispersion. The first input test signal filter 550 is required for the situation where user wavelengths are present on the input fiber span. Since only a small portion of the optical power is siphoned off by tap 1545, the majority of the optical power for both the test signal and the user wavelengths is passed through the DCE 590.

The filtered input test signal may then flow to tap 2 555 and is further tapped wherein a power reduced portion of the signal continues to flow to a photodiode 2 and the remaining power reduced portion flows to a test signal processor 560 where dispersion may be measured or calculated based upon the received test signal.

The test signal processor 560 may process the input test signal as appropriate and may be in electrical communication with a test signal generator 565 such that electrical signals may be transmitted to the test signal generator 565 via an electrical transmission path (depicted as dotted line 580). The test signal generator 565 may then be instructed to generate an “output test signal” that may be further transmitted to the output test signal filter 570 wherein the signal may be combined with a “transmit output data” signal at the output test signal filter 570 and further transmitted to a LINE OUTPUT connector 575. The output test signal, in conjunction with the input test signal, may then be used to measure the dispersion of a fiber span coupling the circuit pack 505 to another network element.

The output test signal filter 570 may be an optical filter of a different optical wavelength(s) than those wavelengths contained within the transmit output data signal. Given that the output test signal may be created such that it is the same wavelength as the input test signal, it may be suitable for measuring dispersion present on the fiber span. In an alternative example embodiment, chromatic dispersion may also be determined using multiple wavelengths by launching a pulse train at the transmitting node simultaneously using at least two different wavelengths and measuring the phase difference of the multiple wavelengths upon arrival at the DME 510 of a receiving node.

Continuing to refer to FIG. 5, the power reduced portion of the input optical signal flows out tap 1 545 and flows to the DC OUT connector 515, through the DCE 590, back in the circuit pack 505 via DC IN connector 520, and to the second input test signal filter 525. As mentioned above, the majority of the optical power for both the test signal and user wavelengths is passed through the DCE 590 and arrives at the second input test signal filter 525, where the optical power associated with the test signal can be measured after filtering. Thus, in this embodiment, the fiber span insertion loss and the DCE's insertion loss can be directly determined by making one measurement at photodiode 4 (assuming the optical power of the test signal is launched with a known power level at the transmitting optical network node).

Thus, the implementation with respect to circuit pack “type 2B” 505 similarly provides the ability to perform fiber dispersion, fiber insertion loss, and DCE 590 insertion loss measurements, and these measurements may be conducted in the presence or absence of user communication signals and in the presence or absence of a dispersion compensation element.

FIG. 6 is a more detailed block diagram of a network element 600 employing an implementation of another alternative circuit pack “type 2C” 605 according to an example embodiment of the invention. In this embodiment, the DME 610 follows the DCE 625 rather than preceding the DCE 625 as was the case with the embodiments described above with reference to FIG. 4 (type 2A) and FIG. 5 (type 2B). Here, the full optical power of the test signal is allowed to pass through the DCE 625 and can be measured at a single point (photodiode 2), thereby simplifying total insertion loss measurements (i.e., the combination of fiber span and DCE). However, when the DCE 625 is present, dispersion measurements of the span itself may require knowledge of the particular DCE 625 installed in the network, since the dispersion measurement is made after the DCE. In this case, if the DCE is a tunable DCE, then the DCE may be set to “0 dispersion compensation” prior to making the dispersion measurement of the span.

In this embodiment, the input optical signal arrives at a LINE IN connector 640, and flows to tap 3 675 wherein a power reduced portion of the input optical signal flows to photodiode 3 and the remaining portion flows out a DC OUT connector 620, through the DCE 625, and back in the circuit pack 605 via a DC IN connector 615. The signal continues to flow to the DME 610, and on to the input test signal filter 635 chosen to separate out the input test signal from the input optical signal. The input test signal flows to tap 2 640 wherein a power reduced portion of the signal flows to photodiode 2 and the remaining power reduced portion flows to a test signal processor 645, where dispersion is measured or calculated based upon the received test signal.

The test signal processor 645 may process the input test signal as appropriate and may be in electrical communication with a test signal generator 650 such that electrical signals may be transmitted to the test signal generator 650 via an electrical transmission path. The test signal generator 650 may be instructed to generate an “output test signal” that is further transmitted to the output test signal filter 655 wherein the signal may be combined with a “transmit output data” signal at the output test signal filter 655 and further transmitted to a LINE OUTPUT connector 660.

In the absence of the DCE, the signal arriving at Line in 640 may be routed to the DME 610 by placing an optical jumper cable between DC in and DC out on circuit pack 605. Dispersion can then be measured or calculated based on the received test signal.

The output test signal filter 655 may be an optical filter of a different optical wavelength(s) than those wavelengths contained within the transmit output data signal. Since the output test signal may be generated such that it is of the same wavelength as the input test signal, it may be suitable for measuring dispersion of the fiber span. In an alternative embodiment, chromatic dispersion may also be determined using multiple wavelengths by launching a pulse train at the transmitting node simultaneously using at least two different wavelengths and measuring the phase difference of the multiple wavelengths upon arrival at the DME 610 of a receiving node.

Thus, in the embodiment illustrated in circuit pack type 2C, insertion loss related to the span and DCE 625 may be measured at photodiode 2, both in the presence or absence of user traffic signals. In addition, the insertion loss of only the fiber span can be directly measured using photodiode 3 (assuming no user wavelengths are present).

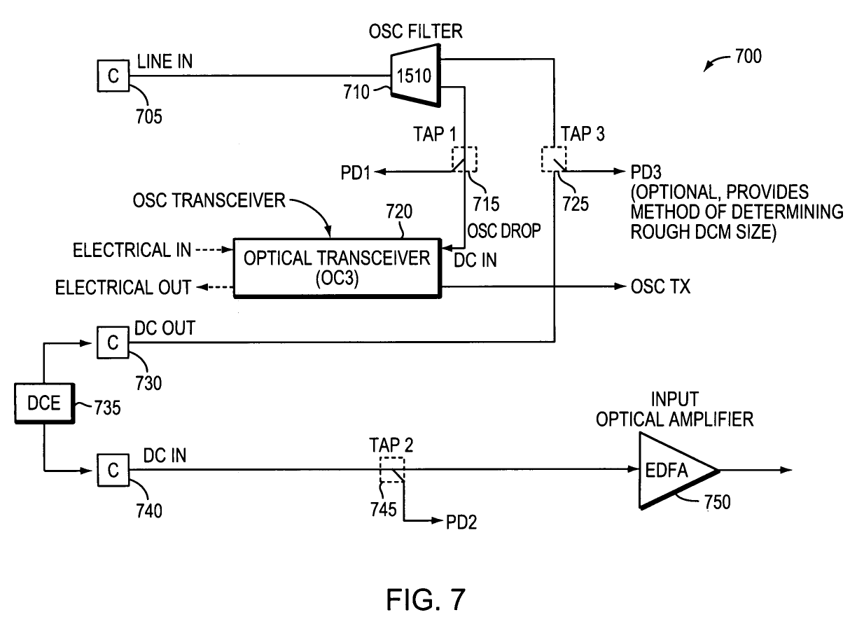

FIG. 7 is a schematic diagram 700 illustrating in additional detail the implementation described above in reference to FIG. 4 with respect to circuit pack “type 2A” according to an example embodiment of the invention. In this embodiment, an optical supervisory channel (OSC), commonly available in most DWDM systems, is used as a test signal for span dispersion and span insertion loss measurements. As a result, the OSC signal may be used to measure span dispersion, span insertion loss, and DCE 735 insertion loss in a similar manner as that described above in reference to FIG. 4.

An input optical signal arriving at a LINE IN connector 705 flows to an OSC filter 710 where the OSC signal is separated and transmitted to tap 1 715 wherein the signal is tapped and a power reduced portion of the signal is transmitted to photodiode 1 which may be used to measure span insertion loss. The remaining power reduced portion of the OSC signal is transmitted to an optical transceiver 720. User data traffic (e.g. the 44 C-band wavelengths) may flow out the upper leg of the OSC filter 710 and on to tap 3 725 wherein the signals are tapped and a power reduced portion of the user traffic flows to photodiode 3 and the remaining power reduced portion of the user data signal flows to a DC OUT connector 730, through the DCE 735 and back to the DC IN connector 740. The signal continues to flow to tap 2 745 wherein the signal is further tapped and a power reduced portion of the signal flows to photodiode 2 and the remaining power reduced portion of the signal flows to the input optical amplifier 750.

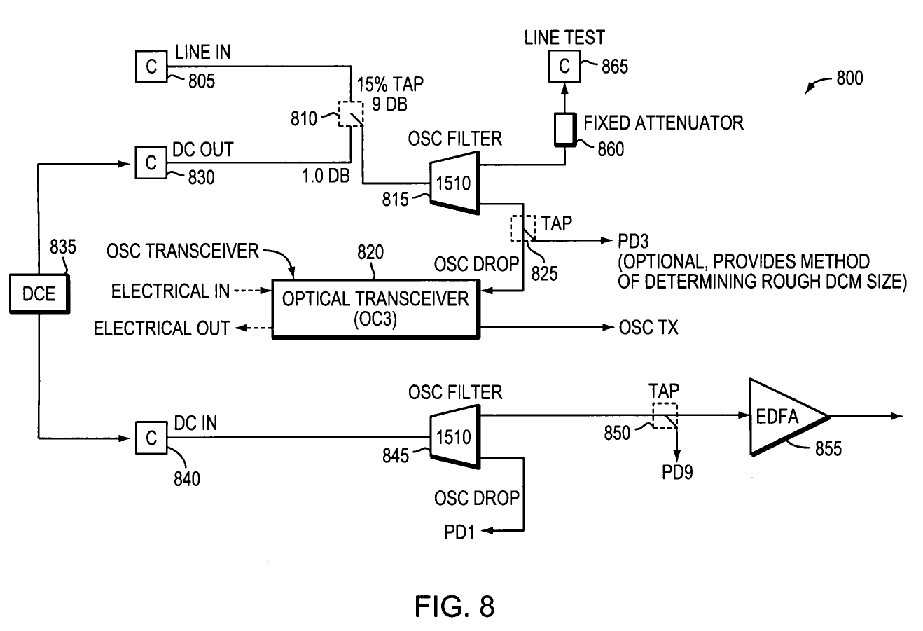

FIG. 8 is a schematic diagram 800 representing in additional detail the implementation described above with reference to FIG. 5 with respect to circuit pack “type 2B” according to another example embodiment. This embodiment also makes use of the OSC signal as a test signal for span dispersion and span insertion loss measurements. Thus, the OSC signal may be used to measure span dispersion, span insertion loss, and DCE 835 insertion loss in a similar manner as that described above in reference to FIG. 5.

An input optical signal arrives at a LINE IN connector 805 and flows to a tap 810 wherein the input optical signal is tapped and a power reduced portion of the signal flows to an OSC filter 815 and the remaining power reduced portion flows to a DC OUT connector 830. For example, the tap 810 may be a 15% tap such that 15% of the input optical signal power arriving at the LINE IN connector 805 is tapped off and flows to the OSC filter 815, and the remaining 85% of the signal power flows to the DC OUT connector 830, through the DCE 835 and back in the DC IN connector 840 arriving at an OSC filter 845. The lower leg of the OSC filter 845 separates out the OSC signal and its power may be measured using photodiode 1. The upper leg of the OSC filter 845 transmits the remaining signals to tap 850 wherein a power reduced portion of the signal flows to photodiode 9 and the remaining power reduced portion flows to the amplifier 855. The lower leg of the other OSC filter 815 separates out the OSC signal where flows to tap 825 and a power reduced portion of the signal flows to photodiode 3 and the remaining power reduced portion flows to the optical transceiver 820. The unfiltered wavelengths flows out the upper leg of the OSC filter 815, then to a fixed attenuator 860, and a line test connector 865.

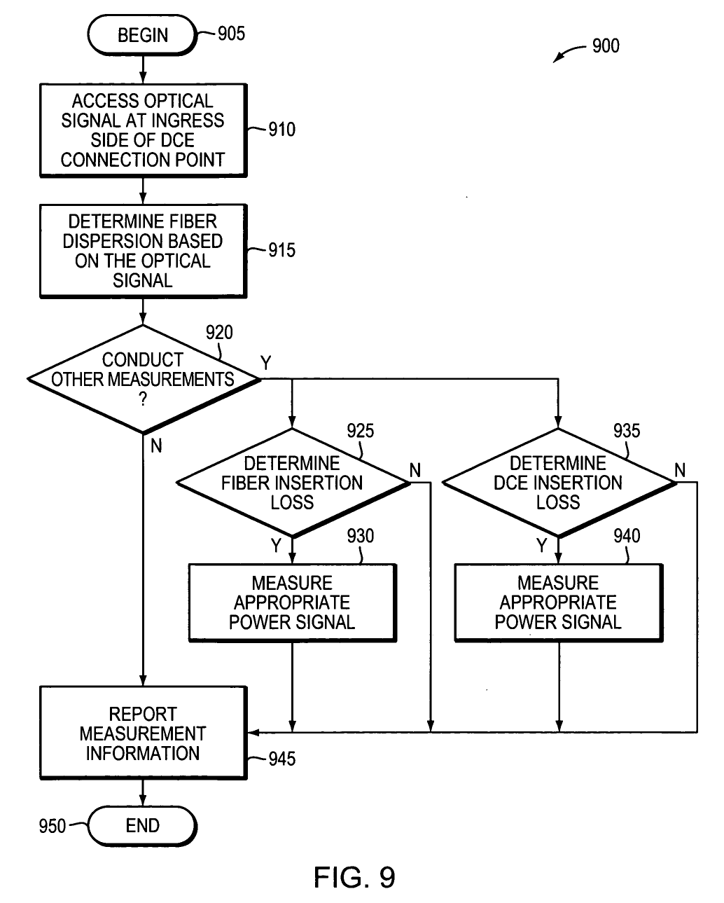

FIG. 9 is a flow diagram of a process 900 illustrating an example embodiment of the invention. The process 900 begins (905) and may access an optical signal at an ingress side of a connection point for a DCE coupling an egress side of a fiber span at the ingress side of the DCE to an optical amplifier at a connection point for an egress side of the DCE (910). Chromatic dispersion of a fiber span may be determined based on the input optical signal (915). The process 900 may then determine if other measurements are to be performed (920), and if so the process 900 determines if fiber insertion loss measurements are to be performed (935) or if DCE insertion loss measurements are to be performed (945), and if so appropriate power measurements are performed (940, 950). After the measurements have been performed, the measured results may be reported (945) to, for example, a system operator, element management system (EMS), server, or the like, and then the process ends (950).

It should be understood that the process 900 described in FIG. 9 is an example embodiment used for illustrative purposes only. Other embodiments within the context of performing dispersion or insertion loss measurements or similar network characteristics may be employed. Furthermore, the techniques illustrated in FIG. 9 may be performed sequentially, in parallel or in an order other than that which is described. It should be appreciated that not all of the techniques described are required to be performed, that additional techniques may be added, and that some of the illustrated techniques may be substituted with other techniques.

Some or all of the process 900 may be implemented in hardware, firmware, or software. If implemented in software, the software may be (i) stored locally with the network node, such as a circuit pack, or some other remote location, or (ii) stored remotely and downloaded to the network node when, for example, the process 900 begins (905). The software may also be updated locally or remotely. To begin operations in a software implementation, the network node loads and executes the software in any manner known in the art. It should be apparent to those of ordinary skill in the art that methods involved in the invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While this invention has been particularly shown and described with references to example embodiments thereof, it will be understood by those skilled in the art that various changes in form and details may be made therein, for example in a computer program product or software, hardware or any combination thereof, without departing from the scope of the invention encompassed by the appended claims.

What is claimed is:

1. A method of configuring a network link, the method comprising:
accessing an optical signal at an ingress side of a connection point for a dispersion compensation element (DCE) coupling an egress side of a fiber span at the ingress side of the DCE to an optical amplifier at a connection point for an egress side of the DCE;
determining chromatic dispersion of the fiber span based on the optical signal; and
reporting information associated with the chromatic dispersion.

2. The method according to claim 1 further comprising:
determining a first power level of the optical signal at the ingress side of the DCE and a second power level at a transmitter side of a forward path of the fiber span toward the DCE; and
reporting fiber span insertion loss based on a differential of the first and second power levels.

3. The method according to claim 1 further comprising:
determining a first power level of the optical signal at an ingress side of a connection point for a DCE and a second power level at an egress side of a connection point for the DCE; and
reporting DCE insertion loss based on a differential of the first and second power levels.

4. The method according to claim 1 wherein the optical signal is an optical test signal and wherein accessing the optical test signal includes separating at least a portion of the optical test signal from other signals before determining the chromatic dispersion of the fiber span.

5. The method according to claim 1 wherein the optical signal is an optical test signal and wherein accessing the optical signal includes tapping a percentage of the optical test signal along with other optical signals, if present, and separating the optical test signal from the other optical signals, if present.

6. The method according to claim 1 wherein determining chromatic dispersion includes detecting a time difference between two optical signals at different wavelengths in a forward direction of the fiber span.

7. The method according to claim 1 wherein determining chromatic dispersion includes determining chromatic dispersion in the presence of a DCE.

8. The method according to claim 1 wherein determining chromatic dispersion includes determining chromatic dispersion in the absence of a DCE.

9. The method according to claim 1 wherein determining chromatic dispersion further includes:
determining length of the fiber span; and
calculating the chromatic dispersion based on the length.

10. The method according to claim 1 wherein determining chromatic dispersion further includes:
determining length of the fiber span; and
calculating the chromatic dispersion based on the length and fiber type.

11. The method according to claim 1 further including configuring the DCE based on the chromatic dispersion.

12. The method according to claim 11 wherein configuring the DCE includes configuring the DCE based on at least one of the following: a predetermined value, stored value, calculated value, instruction, or event.

13. The method according to claim 11 wherein configuring the DCE includes tuning the DCE.

14. The method according to claim 1 further comprising:
accessing the optical signal at the egress side of the DCE;
determining insertion loss of the DCE based on a difference between power levels of the optical signal at the ingress and egress sides; and
reporting the insertion loss.

15. The method according to claim 14 further comprising:
determining insertion loss of the fiber span; and
adjusting gain of the optical amplifier as a function of both insertion losses.

16. The method according to claim 14 wherein accessing the optical test signal includes separating at least a portion of the optical test signal from other signals before determining the insertion loss.

17. The method according to claim 16 wherein determining insertion loss further includes measuring leakage power of the filtered optical test signal during a period in which no user signals are on the fiber span.

18. The method according to claim 17 wherein adjusting gain of the optical amplifier includes adjusting the gain as a function of the leakage power.

19. The method according to claim 17 wherein measuring the leakage power includes measuring the leakage power at the egress side of the DCE.

20. The method according to claim 17 further including reporting insertion loss based on a differential of power levels on the ingress and egress sides of the DCE.

21. An apparatus for configuring a network link, comprising:
an accessing unit configured to access an optical signal at an ingress side of a connection point for a dispersion compensation element (DCE) coupling an egress side of a fiber span at the ingress side of the DCE to an optical amplifier at a connection point for an egress side of the DCE;
a determination unit configured to determine chromatic dispersion of the fiber span based on the optical signal; and
a reporting unit configured to report information associated with the chromatic dispersion.

22. The apparatus according to claim 21 wherein the determination unit is configured to determine a first power level of the optical signal at the ingress side of the DCE and a second power level at a transmitter side of a forward path of the fiber span toward the DCE and wherein the reporting unit is configured to report fiber span insertion loss based on a differential of the first and second power levels.

23. The apparatus according to claim 21 wherein the determination unit is configured to determine a first power level of the optical signal at an ingress side of a connection point for a DCE and a second power level at an egress side of a connection point for the DCE and wherein the reporting unit is configured to report DCE insertion loss based on a differential of the first and second power levels.

24. The apparatus according to claim 21 wherein the optical signal is an optical test signal and wherein the accessing unit is configured to separate at least a portion of the optical test signal from other signals before the determination determines the chromatic dispersion of the fiber span.

25. The apparatus according to claim 21 wherein the optical signal is an optical test signal and wherein the accessing unit is configured to tap a percentage of the optical test signal along with other optical signals, if present, and to separate the optical test signal from the other optical signals, if present.

26. The apparatus according to claim 21 wherein the determination unit is configured to detect a time difference between two optical signals at different wavelengths in a forward direction of the fiber span.

27. The apparatus according to claim 21 wherein the determination unit is configured to determine chromatic dispersion in the presence of a DCE.

28. The apparatus according to claim 21 wherein the determination unit is configured to determine chromatic dispersion in the absence of a DCE.

29. The apparatus according to claim 21 wherein the determination unit is further configured to determine length of the fiber span and calculate the chromatic dispersion based on the length.

30. The apparatus according to claim 21 wherein the determination unit is further configured to determine length of the fiber span and calculate the chromatic dispersion based on the length and fiber type.

31. The apparatus according to claim 21 further including a compensation processor to configure the DCE based on the chromatic dispersion.

32. The apparatus according to claim 31 wherein the compensation processor is configured to tune the DCE based on at least one of the following: a predetermined value, stored value, calculated value, instruction, or event.

33. The apparatus according to claim 31 wherein the compensation processor is configured to tune the DCE.

34. The apparatus according to claim 21 wherein:
the accessing unit is further configured to access the optical signal at the egress side of the DCE;
the determination unit is further configured to determine insertion loss of the DCE based on a difference between power levels of the optical signal at the ingress and egress sides; and
the reporting unit is further configured to report information associated with the insertion loss.

35. The apparatus according to claim 34 wherein the determination unit is configured to determine insertion loss of the fiber span and adjust gain of the optical amplifier as a function of both insertion losses.

36. The apparatus according to claim 34 wherein the accessing unit is configured to separate at least a portion of the optical test signal from other signals before determining the insertion loss.

37. The apparatus according to claim 36 wherein the determination unit is configured to measure leakage power of the filtered optical test signal during a period in which no user signals are on the fiber span.

38. The apparatus according to claim 37 wherein the determination unit is configured to adjust the gain as a function of the leakage power.

39. The apparatus according to claim 37 wherein the determination unit is configured to measure the leakage power at the egress side of the DCE.

40. The apparatus according to claim 37 wherein the reporting unit is configured to report insertion loss based on a differential of power levels on the ingress and egress sides of the DCE.
